(19) United States
(12) Patent Application Publication
(10) Pub. No.: US 2025/0339844 A1
(43) Pub. Date: Nov. 6, 2025

(54) Dry Formulations of Micron-Scale Adsorbents

(71) Applicant: Regenesis Bioremediation Products, San Clemente, CA (US)

(72) Inventors: Paul R. Erickson, San Clemente, CA (US); Chase Hartsell, San Clemente, CA (US); Yen-Ling Liu, San Clemente, CA (US)

(21) Appl. No.: 19/186,900

(22) Filed: Apr. 23, 2025

Related U.S. Application Data
(60) Provisional application No. 63/642,112, filed on May 3, 2024.

(51) Int. Cl. B01J 20/28; B01J 20/30; B09C 1/08; C02F 1/28

(52) U.S. Cl. CPC B01J 20/2803; B01J 20/28004; B01J 20/28016; B01J 20/3028; B01J 20/3042; B01J 20/3078; B09C 1/08; C02F 1/288

(57) ABSTRACT

Formulations and methods of use are disclosed for dry micron-scale adsorbents. An adsorbent material can be provided at a D95 value of 0.1 to 5 microns in diameter size. The micron-scale adsorbent can be dried such that its moisture content is reduced to 50% or less. The micron-scale adsorbent can be agglomerated, optionally alongside a component like a distribution enhancement agent, a binder, a removal enhancement agent, a disintegrant, and/or a dedusting agent. A component, either as part of the agglomerate or by being placed proximal to the agglomerate, may not readily react with the agglomerate, as may be the case for agglomerates with a higher moisture content. This allows for micron-scale adsorbents to be transported and delivered to sites like contaminated soils or municipal water treatment facilities while making transportation more efficient and mitigating dust scattering effects.

### CROSS-REFERENCE TO RELATED APPLICATIONS

This application relates to and claims the benefit of U.S. Provisional Application No. 63/642,112 filed May 3, 2024, and entitled “DRY FORMULATIONS OF MICRON-SCALE ADSORBENTS,” the entire disclosure of which is hereby wholly incorporated by reference.

### STATEMENT RE: FEDERALLY SPONSORED RESEARCH/DEVELOPMENT

Not Applicable

### BACKGROUND

### 1. Field of Invention

The present application relates to the storage and transportation of micron-scale adsorbents for applications ranging from contaminated site remediation to municipal water treatment. More specifically, the present application relates to dry micron-scale adsorbent formulations which can be formed into dry agglomerates, thus increasing transportation efficiency and preventing components like distribution enhancement agents proximal to the agglomerate from prematurely reacting with the agglomerate.

### 2. Related Art

Aqueous suspensions of micron-scale activated carbon are useful in a large and growing number of industries and applications. Known by names such as liquid activated carbon, micron-scale carbon, colloidal activated carbon (CAC), and superfine powdered activated carbon, such activated carbon can be differentiated from typical powdered activated carbon (PAC) in that it has a significantly smaller particle size. Powdered activated carbon particles are usually denoted as having a D95 value ranging from 10-100 micrometers in diameter size, meaning that 95% of the particles (by weight and/or volume) have a particle size at or lower than the D95 value. Colloidal activated carbon particles, on the other hand, are usually denoted as having a D95 value ranging from 0.1-10 micrometer in diameter size, meaning that 95% of the particles (by weight and/or volume) have a particle size at or lower than this range. Other adsorbent materials may be made of a similar colloidal size and used in similar ways as described for colloidal activated carbon. Examples of adsorbents include but are not limited to activated carbon, ion exchange resin, clay mineral, modified clay mineral, cyclodextrin polymers, biochar, iron oxides, iron, natural organic matter, and combinations thereof. Any of these adsorbents when present in the colloidal or near colloidal form can be referred to as micron-scale adsorbents (MSA). Micron-scale adsorbents having a D95 value of ranging from 0.1-5 micrometers in diameter size are of particular relevance in the context of this disclosure.

Employing smaller size of micron-scale adsorbents as opposed to powdered activated carbon or other relatively large adsorbents may bring a range of benefits, including quicker adsorption of solutes from an aqueous solution, slower settling in an aqueous suspension, and better ability to flow or diffuse into porous media such as soils in water-bearing zones or vadose areas. For some of these applications, the smaller particle size is essential to permit use of the adsorbents in application methods like low-pressure injection or to achieve more efficient diffusion into low permeability soil types after soil mixing. In other areas of use like water treatment, the improved kinetics of adsorption of micron-scale adsorbents can yield a substantial improvement over relatively larger sized adsorbents. This performance improvement has already been demonstrated at the pilot and full commercial scale with activated carbon. Methods relevant to this present disclosure include those described in U.S. Pat. No. 7,585,132 entitled “METHOD FOR REMEDIATING A CONTAMINATED SITE”, U.S. Pat. No. 9,776,898 entitled “TREATMENT OF AQUIFER MATRIX BACK DIFFUSION”, U.S. Pat. No. 11,253,895 entitled “METHODS FOR REMEDIATING CONTAMINATED SOIL AND GROUNDWATER USING SOLID-PHASE ORGANIC MATERIALS”, U.S. Pat. No. 11,278,943 entitled “COMPOSITIONS AND FOR METHODS REMOVING CHLORINATED HYDROCARBONS”, U.S. Patent Publication No. 2022/0111423 entitled “METHODS OF CLEANING IN PLACE”, and U.S. Patent Publication No. 2024/0377378 entitled “TRACER METHODS FOR THE DETERMINATION OF SORBENT CONTENT IN SOILS, and U.S. patent application Ser. No. 18/953,441 entitled “SOIL MIXING PROCESSES FOR STABILIZING CONTAMINATED SOIL WHILE MITIGATING DUST SCATTER”, the disclosures of each of which are wholly incorporated herein by reference in their entirety.

Between colloidal activated carbon and other types of micron-scale adsorbents, more work has been published on colloidal activated carbon. This is partially due to the wider availability of activated carbon, its lower cost, and the relative ease of reducing its particle size compared to other adsorbents. Colloidal activated carbon is almost exclusively manufactured by wet milling or other size reduction methods that start with powdered activated carbon or larger granular carbon feedstocks and use physical methods to bring the activated carbon down to a desired size range. Generating micron-scale adsorbents from larger adsorbent particles is usually unattainable by conventionally-known dry manufacturing processes, including jet, hammer, or ball milling. Even if micron-scale adsorbents were more readily attainable from such processes, working with dry solids on this scale can present hazards due to dust and explosion risks that can arise from high energy processing of combustible materials. Wet methods, on the other hand, are well-established, and by using dispersants and other milling or grinding assistance agents, stable aqueous suspensions of colloidal activated carbon can be made with very high solids content, at times approaching or even exceeding 50% solid activated carbon by weight. These aqueous suspensions can be made into useful products for a range of industries which employ activated carbon, including but not limited to soil, groundwater, and sediment remediation, drinking water treatment, wastewater treatment, stormwater management, and construction dewatering. To obtain a desired final functionality of the colloidal activated carbon-containing product, a host of additive components may be added to these formulations. These can range from, but are not limited to, thickeners and other viscosity modifiers, chelates, and particle transport modifiers. U.S. Pat. No. 9,770,743 entitled “COLLOIDAL AGENTS FOR AQUIFER REMEDIATION” and U.S. Pat. No. 10,512,957 entitled “COLLOIDAL AGENTS FOR AQUIFER AND METALS REMEDIATION”, both of which are wholly incorporated herein by reference, disclose various compositions using these components. The water content of the aqueous-based finished products can range substantially, typically from 50 to 99%.

Since micron-scale adsorbents are commonly, but not exclusively, used in aqueous settings as described above, producing a product with high water content can be beneficial, as the product can be more readily delivered in an aqueous environment. There are, however, distinct disadvantages of producing adsorbent materials as aqueous-based products. First, the water content of aqueous-based micron-scale formulations add volume and weight to the product, potentially accounting for more than half of the product's weight and/or volume. Since this added volume and weight would be effectively stored and shipped alongside the solid adsorbent content, transporting the product from a facility where the product is produced to a site where the product would be delivered becomes inefficient and less economical. Another disadvantage is that when these aqueous suspensions are stored, uncontrolled settling of the micron-scale adsorbents can occur. This can create a layer of solids at the bottom of a container that is very difficult, and at times not practical, to resuspend. This settling issue limits the product's shelf life and stability. While this settling process can be mitigated by the addition of viscosity modifiers and thickening agents, the additives can be degraded biologically or abiotically over time in the aqueous suspension, and/or adversely affect the micron-scale adsorbents' performance. Lastly, for some applications of micron-scale adsorbents it may be desirable to package or otherwise place certain components in close proximity to the solid micron-scale adsorbent which may later aid in the product's end-use but which are incompatible with storage in an aqueous medium. Such incompatibility may arise from one or more of these components having an instability in water. If these components remain in solution for an extended period of time, such as while storing or shipping the solution, this incompatibility may prove detrimental to the desired function or end use of the product. Another type of incompatibility may arise if the component is capable of activating a chemical process and the component is intended to activate that chemical process at some stage of the product's end use; co-storage of such a component in an aqueous solution may initiate this process prematurely. As such, it can be seen that there is a need in the art for improved formulations and processes for manufacturing micron-scale adsorbent products which can yield low-water content micron-scale adsorbents and permit efficient transportation and delivery of such adsorbents.

### BRIEF SUMMARY

To solve these and other problems, formulations and methods are disclosed for manufacturing a micron-scale adsorbent with low moisture content that both prevents dust scatter and precludes reactions with components that may otherwise occur at higher moisture contents. A method of manufacturing a dry formulation of a micron-scale adsorbent according to the present disclosure may comprise the steps of providing the micron-scale adsorbent having a D95 value from 0.1-5 microns in diameter size and drying the micron-scale adsorbent to reduce the moisture content of the micron-scale adsorbent to 50% or less, preferably 40% or less, even more preferably 30% or less, and most preferably 25% or less by final weight of the dry formulation. The micron-scale adsorbent could comprise activated carbon, ion exchange resin, clay mineral, modified clay mineral, cyclodextrin polymers, biochar, iron oxides, iron, natural organic matter, or combinations thereof.

The micron-scale adsorbent may be dried via bed drying, tray drying, rotary drying, spray drying, industrial oven drying, freeze drying, vacuum drying or combinations thereof. After drying, the method may further comprises a step of agglomerating the dry formulation to produce a dry agglomerate. The agglomeration process could comprise pin mixing, pan/disc pelletizing, fluidized bed granulation, drum granulation, extrusion or compaction methods, spray drying agglomeration, dedusting agglomeration, or combinations thereof. Any agglomerates may have a size ranging from 0.01 mm to 100 mm.

The agglomeration process could further comprise agglomerating a component with the dry formulation, the component potentially comprising a distribution enhancement agent, a binder, a removal enhancement agent, a disintegrant, a dedusting agent, or combinations thereof. The distribution enhancement agent can comprise chelating agents, anionic polymers, anionic surfactants, nonionic surfactants, and combinations thereof. The binder may comprise modified starches, microcrystalline cellulose, gelatin, sucrose, xanthan gum, lignin, lignosulfonate, chitosan, methylcellulose, sodium carboxymethylcellulose, ethylcellulose, clay minerals, and combinations thereof. The removal enhancement agent could comprise an oxidant or a reductant. A disintegrant can comprise Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, and combinations thereof. The dedusting agent may comprise anionic surfactants, nonionic surfactants, cationic surfactants, amphoteric surfactants, and combinations thereof.

An agglomerate may be transported to a site where the micron-scale adsorbent is to be deployed. As an alternative, or in addition to, the agglomerate containing a component, a component may be transported alongside the agglomerate such that it is proximal to the dry agglomerate, which may come in the form of the component being in contact with the agglomerate during at least part of the transportation process. The species may travel a distance of at least 1 mile and could be transported over land and/or water before reaching the site. The agglomerates may then be disintegrated such that the micron-scale adsorbents and any components are delivered to the site, such as a contaminated soil, a waste water treatment site such as a treatment process unit, a site associated with stormwater management, a site associated with construction dewatering, or a site which is anticipated to be impacted in the future such that the adsorbent is delivered to the site as a proactive measure. The micron-scale adsorbents may treat contaminants present at the site or contaminants which are anticipated to be at the site at a later date, such as metals, petroleum hydrocarbons, herbicides, pesticides, halogenated hydrocarbons, halogenated dibenzodioxins, polychlorinated biphenyls (PCBs), per- and polyfluoroalkyl substances (PFAS), tire-derived chemicals, contaminants from pharmaceuticals and personal care products (PPCPs), taste and odor compounds, cyanotoxins, or combinations thereof.

All of these embodiments are contemplated to be within the scope of this disclosure. These and other embodiments will become readily apparent to those skilled in the art from the following detailed description of the preferred embodiments, the disclosure not being limited to any particular preferred embodiment.

### DETAILED DESCRIPTION

The following disclosure encompasses various embodiments of dry formulations and methods of using such dry formulations to treat sites like contaminated soils, groundwater, or water treatment units. A micron-scale adsorbent may be provided having a D95 value of 0.1 to 5 microns in diameter size. The adsorbent may be dried to reduce its moisture content to 50% or less, preferably 40% or less, even more preferably 30% or less, and most preferably 25% or less to produce a dry formulation. This formulation may then be agglomerated, optionally alongside a component like a distribution enhancement agent, a binder, a removal enhancement agent, a disintegrant, and/or a dedusting agent to form a dry agglomerate. This agglomerate may beneficially prevent the micron-scale adsorbent from spreading as dust while also reducing the size and weight that water would otherwise contribute, making it easier to transport. In addition, any component present in an agglomerate or placed proximal to the dry agglomerate may not be prone to reacting with the dry agglomerate, as may be the case with an agglomerate with a higher moisture content. As such, the micron-scale adsorbent and any components may be efficiently transported to a site; the agglomerates may be disintegrated at the site to effectively deliver the adsorbent to the site.

This description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

The process of manufacturing a dry formulation according to this disclosure may begin with selecting an adsorbent material. The adsorbent material may comprise activated carbon, ion exchange resin, clay mineral, modified clay mineral, cyclodextrin polymers, biochar, iron oxides, iron, natural organic matter, and combinations thereof. A particular adsorbent material may be chosen based on an anticipated application of the formulation. For example, an adsorbent material could be chosen based on its effectiveness at treating a particular contaminant or its suitability for treating a certain site which the adsorbent is to be delivered to. A contaminant or site may be examined or experimented upon in order to guide one in selecting an effective adsorbent material for a particular application. Contaminants which may be treated by the formulations and methods disclosed herein may comprise metals, petroleum hydrocarbons, herbicides, pesticides, halogenated hydrocarbons, halogenated dibenzodioxins, polychlorinated biphenyls (PCBs), per- and polyfluoroalkyl substances (PFAS), tire-derived chemicals like 6PPD-Q, pharmaceutical-based contaminants such as sulfonamide antibiotics, steroid hormones, and quinolones, contaminants originating from personal care products, such as Triclosan, taste and odor compounds like 2-methylisoborneol and geosmin, cyanotoxins such as microcystins, nodularins, and anatoxin-a, or combinations thereof. However, it is contemplated that this disclosure need not be limited to the contaminants listed herein or on currently known/classified contaminants, given that new and emerging contaminants are continually arising. In this respect, this disclosure need not be limited and may be capable of treating any such new and emerging contaminants.

Some contaminants are more prevalent in stormwater, like tire-derived chemicals, or surface water, such as pharmaceuticals and personal care products (PPCPs), taste and odor compounds, and cyanotoxins. Tire-derived chemicals are substances that may be released into the environment from the wear and tear of tires, and they can be washed into water bodies during rain events. 6PPD-Q, as one well-known contaminant in the tire-derived chemicals category, is highly toxic to aquatic life. PPCPs can enter the environment through various pathways, including human and animal excretion, wastewater treatment plants, and pharmaceutical manufacturing and hospital waste. Many PPCPs are persistent and bioaccumulate in the ecosystem, posing potential health effects. Taste and odor compounds can contaminate drinking water due to algae in surface water, minerals and sulfurous compounds in groundwater, or other contamination. Taste and odor compounds primarily raise aesthetic concerns. Cyanotoxins are commonly present in water sources during harmful algal blooms. These toxins can cause various health problems, including liver and kidney damage; hence, managing cyanotoxins is critical in public drinking water systems.

One or more types of components which may enhance the functionality of the adsorbent material in its intended application may also be selected at this stage. Again, any components selected may be based on their suitability at treating a particular contaminant or site, and prior examination/experimentation may indicate how effective a component may be for a particular application. One example of a component could be a distribution enhancement agent, which may enable the micron-scale adsorbents to distribute significantly further through an aquifer when delivered alongside them. A distribution enhancement agent can comprise chelating agents, anionic polymers, anionic surfactants, nonionic surfactants, and combinations thereof. If the distribution enhancement agent includes chelating agents, they may comprise phosphates, silicates, borates, sulfates, carbonates, aminocarboxylic acids and salts thereof, polyamines, and combinations thereof. If one or more types of anionic polymers are amongst the distribution enhancement agents chosen, they could comprise sulfated or carboxylated polysaccharides, polyacrylates, polyacrylamides, lignosulfonate, polyacrylate copolymers, and combinations thereof. Any nonionic surfactants may comprise alkyl polyethylene oxides, ethylene oxide polymers, polyethylene oxide lauryl ether, ethylene oxide-propylene oxide copolymers, and combinations thereof.

Binders are another class of components that may be included. Examples of binders include but are not limited to starch, modified starches, microcrystalline cellulose, gelatin, sucrose, xanthan gum, lignin, lignosulfonate, chitosan, methylcellulose, sodium carboxymethylcellulose, ethylcellulose, clay minerals, and combinations thereof. A binder's utility may relate to agglomerated formulations, so the advantages these binders may yield will be discussed in relation to those agglomerate formulations later in this disclosure.

A third class of components may be a removal enhancement agent. A removal enhancement agent may increase a micron-scale adsorbent's uptake of contaminants and/or chemically degrade a contaminant or other aqueous component of interest. Examples of removal enhancement agents include oxidants and reductants which function as electron acceptors or electron donors to aid biodegradation of contaminants.

A disintegrant may also or alternatively be a component chosen alongside the micron-scale adsorbent amendment. The disintegrant may accelerate the agglomerate disintegration process and react when the agglomerate is exposed to sufficient moisture, as will be touched on later in this disclosure. The disintegrant can comprises Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, and combinations thereof.

A dedusting agent is another component that may reduce dust by improving the wettability of powders, making them easier to bind together and settle out of the air. A dedusting agent may be added to reduce dust when the moisture content is not sufficient for dust suppression. The dedusting agent could include anionic surfactants, nonionic surfactants, cationic surfactants, amphoteric surfactants, and combinations thereof. It can be seen that surfactants used alongside micron-scale adsorbents may act as both a distribution enhancement agent and a dedusting agent.

To start the process of manufacturing a dry formulation, a micron-scale adsorbent may be obtained. Micron-scale adsorbents having a D95 value between 0.1 and 5 microns, meaning that 95% of the particles (by weight and/or volume) have a particle size at or lower than this range, are of particular relevance in this disclosure. Adsorbents in this size range can be quite susceptible to scattering or combusting in certain environments, creating obvious health and safety concerns. Properly-sized adsorbents can be obtained by starting with a feedstock material and performing a size-reduction method like wet milling.

Once the micron-scale adsorbents in the desired size range have been obtained, a drying process may be performed to remove water from the adsorbent material and produce a dry formulation. In particular, the drying process could comprise bed drying, tray drying, rotary drying, spray drying, drying with an industrial oven, freeze drying, vacuum drying and combinations thereof. Any number of drying processes can be carried out on an adsorbent sample one or more times in any conceivable order. If feasible, one or more drying processes could be performed simultaneously on an adsorbent sample. The drying process may result in the micron-scale adsorbent's moisture content being lowered to 50% or less, preferably 40% or less, even more preferably 30% or less, and most preferably 25% or less, as measured by the final weight of the formulation. Higher or lower moisture content thresholds may be set based on the specific formulation desired. The low moisture content of these dry formulations allow for some components to be placed in close proximity to the dry formulation without reacting with the formulation, even when such components would otherwise react with a formulation having a higher moisture content.

The dry formulation may then be processed further into an agglomerate. In this respect, the agglomeration methods disclosed in Applicant's previously filed U.S. patent application Ser. No. 18/953,441 entitled “SOIL MIXING PROCESSES FOR STABILIZING CONTAMINATED SOIL WHILE MITIGATING DUST SCATTER”, the disclosure of which is wholly incorporated herein by reference, may be used to agglomerate the dry formulations of this present disclosure. The particular agglomeration techniques that may be used in the context of this present disclosure include pin mixing, pan/disc pelletizing, fluidized bed granulation, drum granulation, extrusion or compaction methods, spray drying agglomeration, dedusting agglomeration and combinations thereof. The size of the dry agglomerates produced by these processes may range from 0.01 mm to 100 mm.

Since the desired components may not be prone to reacting with dry formulations of micron-scale adsorbents, such components may be agglomerated alongside the micron-scale adsorbents and form part of the agglomerated formulation. As such, the dry micron-scale adsorbent formulation and any components may be mixed together prior to agglomeration or both species may be simply agglomerated together. Alternatively, the dry micron-scale adsorbent formulation and components may each be agglomerated separately, and the two types of agglomerates can be blended together before being stored or transported. As a third alternative, only the dry micron-scale adsorbent formulation may be agglomerated while the component is maintained in a non-agglomerated state. Any combination of these three approaches can be employed, as may be the case when all of a given dry micron-scale adsorbent formulation is agglomerated with some of a given component, some of the same type or a different type of component is agglomerated separately and blended with the adsorbent-based agglomerate, and a third type of component is not agglomerated and kept in its natural state.

These agglomerates may prevent the micron-scale adsorbent particles from spreading throughout the environment as dust, preventing potential nuisance and health risks when transporting or handling the formulation. By first reducing the micron-scale adsorbent material's moisture content prior to agglomeration, a dry micron-scale adsorbent agglomerate having a low moisture content can be produced, allowing the agglomerate to contain or be placed in close proximity to components which are otherwise susceptible to reacting with agglomerates with a higher moisture content. This permits the agglomerate to be stored for long periods of time or transported over long distances without compromising the integrity and while mitigating any health and safety concerns that could result from dust scatter; the agglomerate also takes up less space and weight due that water may otherwise contribute to, thus saving on transportation costs. The agglomerate and component(s) can be transported to a site, where the micron-scale adsorbent is to be delivered to, over a distance of at least 1 mile, at least 10 miles, at least 50 miles, at least 100 miles, at least 1,000 miles, or at least 5,000 miles. Vehicles like trucks and ships can be used to transport the agglomerate and component(s) to a site over land, sea, or both.

Binders may function to form and maintain agglomerates containing dry micron-scale adsorbent formulations by ensuring the agglomerates remain in a desired agglomerate size range during long-term storage and transportation. Appropriate binders, disintegrants, and dedusting agents would preferably have little adverse impact on the micron-scale adsorbent's performance in its particular application. Adverse impacts could include reducing the micron-scale adsorbent's efficiency in removing contaminants from targeted aquifers or inhibiting the interaction of micron-scale adsorbents and other components present in a dry micron-scale adsorbent agglomerate formulation.

Once transported to a site, agglomerates and any components therein or transported alongside the agglomerates may be delivered to the site by disintegrating the agglomerates. In this respect, the disintegration methods, including supplying moisture to the agglomerates and/or agitating the agglomerates, discussed in Applicant's previously filed U.S. patent application Ser. No. 18/953,441 entitled “SOIL MIXING PROCESSES FOR STABILIZING CONTAMINATED SOIL WHILE MITIGATING DUST SCATTER”, the disclosure of which is wholly incorporated herein by reference. Additional moisture may need to be supplied to account for the lower moisture content of the agglomerates of this present disclosure. It may be desirable to disintegrate the agglomerates to the furthest extent possible so that the micron-scale adsorbents and components can return to their original size and properties as they were before agglomeration; the selection of adsorbents, drying methods, agglomeration methods, and components (particularly binders) may be carefully chosen to achieve a desired distribution and contaminant treatment in a site.

When delivered to the site, the micron-scale adsorbent may, with the help of any relevant components present, treat the site. Treatment at a site may be in the context of treating contaminated soils, wastewater treatment, stormwater management, and construction dewatering, although other contexts having, or which could later have, contaminants which may be treated by the micron-scale adsorbent may also be treated.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. A method of manufacturing a dry formulation of a micron-scale adsorbent, the method comprising the steps of:
providing the micron-scale adsorbent, the micron-scale adsorbent having a D95 value from 0.1-5 microns in diameter size; and
drying the micron-scale adsorbent to reduce the moisture content of the micron-scale adsorbent to 50% or less by final weight of the dry formulation.

2. The dry formulation manufactured by the method of claim 1.

3. The method of claim 1, wherein the micron-scale adsorbent comprises: activated carbon, ion exchange resin, clay mineral, modified clay mineral, cyclodextrin polymers, biochar, iron oxides, iron, natural organic matter, or combinations thereof.

4. The method of claim 1, wherein said step of drying comprises bed drying, tray drying, rotary drying, spray drying, industrial oven drying, freeze drying, vacuum drying, or combinations thereof.

5. The method of claim 1, wherein the method further comprises a step of:
agglomerating the dry formulation to produce a dry agglomerate.

6. The method of claim 5, wherein the agglomerate has a size ranging from 0.01 mm to 100 mm.

7. The method of claim 5, wherein said step of agglomerating further comprises agglomerating a component with the dry formulation to produce the dry agglomerate, the component comprising a distribution enhancement agent, a binder, a removal enhancement agent, a disintegrant, a dedusting agent, or combinations thereof.

8. The method of claim 7, wherein the distribution enhancement agent comprises chelating agents, anionic polymers, anionic surfactants, nonionic surfactants, and combinations thereof.

9. The method of claim 7, wherein the binder comprises modified starches, microcrystalline cellulose, gelatin, sucrose, xanthan gum, lignin, lignosulfonate, chitosan, methylcellulose, sodium carboxymethylcellulose, ethylcellulose, clay minerals, and combinations thereof.

10. The method of claim 7, wherein the removal enhancement agent comprises an oxidant or a reductant.

11. The method of claim 7, wherein the disintegrant comprises Mucilage of Lepidus sativum, Ispaghula husk/seeds, Hibiscus rosa, xanthan gum, agar and treated agar, guar gum, fenugreek, banana powder, locust bean gum, mango peel pectin, gellan gum, soy polysaccharide, chitin, chitosan, gum Karaya, sodium starch glycolate, crospovidone, croscarmellose sodium, crosslinked alginic acid, ion exchange resins, or combinations thereof.

12. The method of claim 7, wherein the dedusting agent comprises chelating agents, anionic polymers, anionic surfactants, nonionic surfactants, or combinations thereof.

13. The method of claim 5, wherein said step of agglomerating comprises pin mixing, pan/disc pelletizing, fluidized bed granulation, drum granulation, extrusion or compaction methods, spray drying agglomeration, dedusting agglomeration, or combinations thereof.

14. A method of treating a site, the method comprising the steps of:
providing a micron-scale adsorbent, the micron-scale adsorbent having a D95 value from 0.1-5 microns in diameter size;
drying the micron-scale adsorbent to reduce the moisture content of the micron-scale adsorbent to 50% or less by final weight of the dry formulation;
agglomerating the dry formulation to produce a dry agglomerate; and
disintegrating the dry agglomerate via supplying moisture to the agglomerates, agitating the agglomerates, or both;
wherein said disintegrating causes the micron-scale adsorbent to be delivered to the site.

15. The method of claim 12, wherein the method further comprises a step of:
transporting the dry agglomerate to the site;
wherein the dry agglomerate travels a distance of at least 1 mile during said step of transporting.

16. The method of claim 13, wherein the dry agglomerate has a size ranging from 0.01 mm to 100 mm.

17. The method of claim 13, wherein said step of agglomerating further comprises agglomerating a component with the dry formulation to produce the dry agglomerate, the component comprising a distribution enhancement agent, a binder, a removal enhancement agent, or combinations thereof.

18. The method of claim 13, wherein said step of transporting the dry agglomerate further comprises transporting a component to the site, the component comprising a distribution enhancement agent, a binder, a removal enhancement agent, or combinations thereof;
wherein during said step of transporting, the dry agglomerate is proximal to the component.

19. The method of claim 12, wherein the site is soil containing a contaminant or a water treatment site containing the contaminant.

20. The method of claim 17, wherein the contaminants comprise metals, petroleum hydrocarbons, herbicides, pesticides, halogenated hydrocarbons, halogenated dibenzodioxins, polychlorinated biphenyls (PCBs), per- and polyfluoroalkyl substances (PFAS), tire-derived chemicals, contaminants from pharmaceuticals and personal care products (PPCPs), taste and odor compounds, cyanotoxins, or combinations thereof.
